(19) United States
(12) Patent Application Publication
(10) Pub. No.: US 2024/0253507 A1
(43) Pub. Date: Aug. 1, 2024

(54) ELECTRIC DRIVING SYSTEM FOR A VEHICLE, VEHICLE HAVING A CORRESPONDING ELECTRIC DRIVING SYSTEM AS WELL AS A METHOD FOR OPERATING A CORRESPONDING ELECTRIC DRIVING SYSTEM

(71) Applicant: MERCEDES-BENZ GROUP AG, Stuttgart (DE)

(72) Inventors: Urs BOEHME, Ehningen (DE); Markus ORNER, Rennigen (DE); Nathan TRÖSTER, Stuttgart (DE)

(21) Appl. No.: 18/292,403

(22) PCT Filed: Jul. 26, 2022
(86) PCT No.: PCT/EP2022/070910

§ 371 Date: Jan. 26, 2024

(30) Foreign Application Priority Data
Jul. 27, 2021 (DE) 10 2021 003 883.5

(51) Int. Cl. B60L 53/62; B60L 53/14; B60L 53/24

(52) U.S. Cl. CPC B60L 53/62; B60L 53/14; B60L 53/24; B60L 2210/42

(57) ABSTRACT

An electric driving system for a vehicle includes a switching device having first and second switching states. In the first switching state, in which a charging port is directly connected with an electrical energy storage device of the vehicle, the electrical energy storage device is charged with an input voltage applied to the charging port. In the second and third switching states the charging port is connected with the electrical energy storage device via an inverter such that the electrical energy storage device can be charged depending on the inverter.

### BACKGROUND AND SUMMARY OF THE INVENTION

Exemplary embodiments of the invention relate to an electric driving system for a vehicle, a vehicle having a corresponding electric driving system, and a method for operating an electric driving system.

Nowadays electrically driven or operated vehicles have a voltage level of 800 volts. Therefore, these vehicles have an 800-volt vehicle battery with which an onboard electrical system and/or an electric driving machine can be provided with energy. For example, this is disclosed in DE 10 2019 005 621 A1 and DE 10 2009 052 680 A1. In order for the electric driving machine of the vehicle to drive the vehicle, it requires an alternating voltage. This alternating voltage is generated by means of an inverter from a battery voltage of the vehicle battery. An example of this is disclosed in DE 10 2018 000 488 A1.

DE 10 2018 009 848 A1 and DE 10 2018 009 840 A1 disclose respective switching arrangements for motor vehicles. In each case, an electric machine of a vehicle is supplied with electrical energy by means of a power converter via a high-voltage battery of the vehicle.

Exemplary embodiments of the present invention are directed to charging an electric vehicle having a voltage level of 800 volts more simply and without additional effort at a 400-volt charging station.

An aspect of the invention relates to an electric driving system for a vehicle, comprising
an electric three-phase motor,
an electrical energy storage device for supplying electricity to the electric three-phase motor,
an inverter, which is connected to the electric three-phase motor, wherein a positive potential of the electrical energy storage device is connected with a positive potential of the inverter and a negative potential of the electrical energy storage device is connected with a negative potential of the inverter, and
a series circuit consisting of a first capacitor and a second capacitor which is switched between the positive and negative potential of the inverter, wherein a center tap of the inverter is formed between the first capacitor and the second capacitor, having:
a switching device which has:
a first switching state in which a positive potential of a charging port is connected with the positive potential of the electrical energy storage device and a negative potential of the charging port is connected with a negative potential of the electrical energy storage device, such that the electrical energy storage device can be charged with an input voltage which is applied to the charging port,
a second switching state in which the positive potential of the charging port is connected with the positive potential of the electrical energy storage device and the negative potential of the charging port is connected with the center tap of the inverter, such that the electrical energy storage device can be charged depending on the inverter, and/or
a third switching state in which the positive potential of the charging port is connected with the center tap of the inverter and the negative potential of the charging port is connected with the negative potential of the inverter, such that the electrical energy storage device can be charged depending on the inverter.

Due to the proposed electric driving system, electrically driven vehicles, in particular electric vehicles, can be charged with a voltage level of 800 volts more simply at a 400-volt charging station and/or charging unit, as the backward compatibility for this can be carried out without additional expense. Consequently, electric vehicles can be operated more efficiently as there is a simpler and improved capability to also be able to carry out charging processes at charging stations with low voltages.

These advantages can therefore be achieved using the inverter of the electric three-phase motor that is already available in the vehicle and in addition to its primary function has a secondary function. The primary function of the inverter is the provision of an alternating voltage for the three-phase motor. The secondary function is the alternative use of an inverter for charging the vehicle, in particular at a 400-volt charging station. Consequently, the backward compatibility of the vehicle can occur without the use of additional components and/or parts, as the inverter is already available in the vehicle. Due to the alternative use of the inverter, in particular due to the use of the secondary function of the inverter, it is possible to save on the costs, weight and installation space of an electric vehicle.

Furthermore, a charging process of the vehicle can take place at a 400-volt charging station due to the switching device and the respective switching states of the switching device, without it being necessary to access the neutral point of the electric three-phase motor or additionally having to take into account or use a corresponding switching element inside of the inverter.

In particular, multiple use of an electric three-phase motor of the vehicle can be enabled with the aid of the proposed electric driving system. Due to the interconnection with the center tap of the first and second capacitors, a charging process can be prepared more efficiently, as the first and second capacitor can be pre-charged to half the voltage of the electrical energy storage device, depending on the switching state of the switching device. During the charging process with the 400-volt charging station, the voltage in the first or second capacitor can gradually increase. This, for example, can be half of the battery voltage. This is advantageous as DC charging stations observe the increase of the DC voltage to check the plausibility of the upcoming charging process. If this does not take place, charging may be terminated. This can be prevented due to the pre-charging of the first or second capacitor to half the voltage of the electrical energy storage device.

For example, the vehicle may be an at least partially electrically operated vehicle. In particular, the vehicle may be an electric vehicle, a hybrid vehicle, or a plug-in vehicle. In particular, the vehicle may be a passenger car or heavy goods vehicle.

The electrical energy storage device may be, for example, a vehicle battery, traction battery, or battery system of the vehicle. In particular, the electrical energy storage device may be a high-voltage battery with a voltage level of 800 volts. The electric three-phase motor may be in particular an electric machine or an electric motor for driving the vehicle for the purpose of locomotion.

In particular, the inverter can be realized or represented as a boost converter or step-up converter with the aid of the switching device, such that the electrical energy storage device can be charged at a charging station with a voltage level lower than that of the electrical energy storage device. In particular this takes place without intervention in the electric three-phase motor. In particular, the input voltage for the charging process can be stepped up. In particular, this can take place by means of the inverter and the center tap between the first and second capacitor.

Optionally, a DC boost function can be realized via the inverter of the electric three-phase motor, by means of the electric driving system. Thus, additional charging units or voltage converters are not necessary for a step-up operation of the input voltage in order to charge the electrical energy storage device.

In particular, the individual positive potentials can belong to a common positive potential. Therefore, the individual positive potentials can be referred to as part potentials of the positive potential. Similarly, the individual negative potentials can belong to a common negative potential. Therefore, the individual negative potentials can be referred to as part potentials of the positive potential.

Specifically, in a first variant, the switching device can have the first and second switching state as possible operating states. In a second variant, the switching device can have the first and third switching state as possible operating states. Likewise, the switching device can have a combination of both variants. Therefore, overloading an electrical insulation of the charging station can be prevented by a potential unbalance in the vehicle in relation to PE.

According to the invention, it is provided that the inverter is set up to charge the first capacitor and/or second capacitor and a sum of a first voltage of the first capacitor and a second voltage of the second capacitor is provided as an output voltage of the inverter for charging the electrical energy storage device. Subsequently, a step-up operation or a boost function can be realized, by using the inverter to connect the center tap between the first and second capacitor with the charging port. In particular, the charging of the first capacitor and/or the second capacitor takes place alternately. In particular, this can take place depending on the current switching state or stroke operation of the inverter. Thus, for example, the first capacitor can be charged in a first stroke and the second capacitor can be charged in a second stroke immediately following the first stroke. During a charging process of the electrical energy storage device at a 400-volt charging station, the first and second capacitor can be charged with a voltage of essentially 400 volts. Thus, the sum of the first and second capacitor can provide the necessary output voltage for the electrical energy storage device.

In a further embodiment of the invention, it is provided that the inverter is formed as a three-level T-type inverter. Due to this specific design of the inverter, a stepped-up operation can be realized without performing an intervention on the neutral point of the electric three-phase motor. For example, by using the inverter as a three-level T-type inverter, the step-down compatibility of the vehicle can be achieved without additional components. For example, the inverter can be formed as a three-level inverter, S-three inverter, or as a three-stage inverter in a T-type design. In particular, the inverter may be formed as a three-level inverter in NPC (Neutral Point Clamped) topology or as a three-point inverter in an NPC circuit. In particular, the inverter is a Neutral Point Clamped three-level inverter. In comparison to the conventionally used 2-level inverters, this has a considerably higher dielectric strength.

In a further embodiment of the invention, it is provided that the inverter is set up to adjust a voltage difference between a battery voltage of the electrical energy storage device and the input voltage in the second switching state by reducing a voltage level of the negative potentials by this voltage difference, and to adjust a voltage difference between the battery voltage and the input voltage by increasing a voltage level of the positive potentials by this voltage difference.

In the second switching state of the switching device, a stepped-up operation can be achieved, in which the positive potential of the charging pillar or the charging station is directly connected with the positive potential of the electrical energy storage device. A voltage adjustment of the voltage difference between the charging station, of for example 400 volts, and the electrical energy storage device, of for example 800 volts, takes place by an adjustment or reduction of the voltage levels in the negative potentials, by for example 400 volts (according to the voltage difference). This voltage difference can therefore be generated by operating a choke or motor winding of the electric three-phase motor cyclically. In this case, cycling operation can be understood as a change from the short circuit or build-up of a choke current in the choke to the opening of the short circuit or freewheeling of the choke current via freewheeling diodes and vice versa. The voltage difference between the charging station and the electrical energy storage device is applied to the blocking freewheeling diode in the choke current build-up. The electrical energy storage device cannot be charged in this moment. Instead, the energy in the choke can be increased by the increasing choke current. In this case, the positive potentials have an identical potential reference.

In the third switching state of the switching device, the negative potential between the vehicle and the charging station are directly connected with each other. The adjustment of the voltage difference between the charging station (400 volts) and the electrical energy storage device (800 volts) takes place by an adjustment or increase of the voltage levels in the positive potentials by 400 volts (according to the voltage difference). The generation of the voltage difference takes place in an analogous manner, as explained above, via the cyclically operated choke. However, the throttle and the freewheeling diode are now located in the positive potential.

In a further embodiment of the invention, it is provided that the switching device has a first charging contactor for connecting the positive potential of the charging port with the positive potential of the electrical energy storage device. In addition, the switching device has a second charging contactor for connecting the positive potential of the charging port with the center tap of the inverter. Instead, the switching device may have a third charging contactor for connecting the negative potential of the charging port with the center tap of the inverter. In addition, the switching device has a fourth charging contactor for connecting the negative potential of the charging port with the negative potential of the inverter.

In particular, the first to fourth charging contactors are electrical switches or switching elements. In particular, the switching device can switch the charging contactors according to which switching state should be adopted. Depending on which switching state the switching device currently adopts or should adopt, the charging contactors of the switching device can be switched accordingly by using a control device or a control unit of the electric driving system, for example.

With the aid of the charging contactors, the switching device can be switched so that either the charging process of the electrical energy storage device can take place via the negative potential or via the positive potential, by means of the inverter. In particular, a charging process of the electrical energy storage device can take place independent from the inverter, in particular with a direct 800-volt charging process, with the aid of the first and fourth charging contactors.

In a further embodiment of the invention, it is provided that the switching device is set up to automatically switch to the first switching state when the input voltage of the charging port has a first predetermined voltage value. Thus, the corresponding switching state can be set or switched automatically, depending on which charging process should be carried out. The first switching state is always used or set automatically when the input voltage corresponds to a first predetermined voltage value. The first predetermined voltage value, in particular, is a voltage value essentially corresponding to the voltage level of the electrical energy storage device. For example, in an 800-volt vehicle with an 800-volt energy storage device, the first predetermined voltage value can correspond to 800 volts. In particular, the charging of the electrical energy storage device takes place in the first switching state directly via the charging port and therefore directly via the charging station.

For example, the switching device can have a control unit or control device with which the automatic switching of the switching states can be carried out. For example, the input voltage can be determined using voltage measuring devices so that this can be taken into account for deciding the switching state to be set.

In a further embodiment it is provided that the switching device is set up to automatically switch to the second switching state when the input voltage of the charging port has a second predetermined voltage value, and the inverter is operated as a boost converter to reduce a voltage level of the negative potentials. As explained above, the switching of the switching state takes place automatically. For example, an automatic change from the first switching state to the second can take place or vice versa. In particular, only one switching state can be currently switched or activated by the switching device.

A second predetermined voltage value is, in particular, a voltage value of the charging station. For example, the predetermined second voltage value is 400 volts at a 400-volt charging station. Furthermore, the second switching state of the switching device is then set or used when the negative potential should be reduced by a voltage difference. In this case, the positive potential between the charging station and the vehicle would be directly connected to each other.

In a further embodiment of the invention, it is provided that the switching device is set up to automatically switch to the third switching state when the input voltage of the charging port has a second predetermined voltage value and the inverter is operated as a boost converter to increase a voltage level of the positive potentials. Reference can be made here to the explanations described above. As with the second switching state, the second predetermined voltage value of 400 volts, for example, is decisive for the use or activation of a third switching state. The third switching state is then automatically set or activated when, in particular, the positive potential of the electric driving system should be adjusted or increased. In this case, the negative potential of the charging station and of the vehicle is directly connected to each other. The voltage level of the positive potentials can be increased by the voltage difference.

In particular, the specified voltage values are understood as target voltage values that may have measurement tolerances and/or tolerances of 5 percent, in particular 10 percent.

The term “essentially” is to be understood in particular as a tolerance of +/−5 percent, specifically +/−10 percent.

A further aspect of the invention relates to a vehicle having an electric driving system according to the preceding aspect or an advantageous embodiment thereof.

In particular, the previously described electric driving system can be integrated into the vehicle. In particular, the vehicle has a corresponding electric driving system according to the preceding aspect.

For example, the vehicle is an electric vehicle or an at least partially electrically operated vehicle. In particular, the vehicle has a voltage level of 800 volts,

In particular, the vehicle can be driven for the purposes of locomotion by means of the electric driving system.

A further aspect of the invention relates to a method for operating an electric driving system according to one of the preceding aspects or an advantageous embodiment thereof, wherein
the electric three-phase motor having the electrical energy storage device is supplied with electricity, comprising
switching the switching device of the electric driving system into the first switching state such that the electrical energy storage device is charged with the input voltage,
switching the switching device into the second switching state, such that the electrical energy storage device is charged depending on the inverter, and/or
switching the switching device into the third switching state, such that the electrical energy storage device is charged depending on the inverter.

In particular, a charging process of an 800-volt electric vehicle can be carried out more simply and without additional effort at a 400-volt charging station by the method.

In particular, the method just described having an electric driving system can be carried out according to one of the preceding aspects or an advantageous embodiment thereof. In particular, the method just described is carried out with the previously described electric driving system.

Advantageous embodiments of the electric driving system are considered advantageous embodiments of the vehicle as well as of the method. The electric driving system as well as the vehicle have representational features which enable the method or an advantageous embodiment thereof to be carried out.

Embodiments of individual aspects are considered advantageous embodiments of the other aspects and vice versa.

Further advantages, features and details of the invention result from the description of preferred exemplary embodiments below, as well as by means of the drawing(s). The features and feature combinations referred to above in the description as well as the features and feature combinations referred to below in the description of the figures and/or shown solely in the figures can be used not only each specified combination but also in other combinations or alone without leaving the scope of the invention.

### BRIEF DESCRIPTION OF THE DRAWING FIGURES

The following figures show:

FIG. 1 a schematic block circuit diagram of an embodiment of an electric driving system according to the invention;

FIG. 2 an exemplary functional sequence of the electric driving system from FIG. 1;

FIG. 3 a schematic representation of a simulation set-up of the electric driving system from FIG. 1;

FIG. 4 exemplary simulation results of the simulation set-up from FIG. 3;

FIG. 5 a schematic block circuit diagram of a further embodiment of the electric driving system from FIG. 1; and

FIG. 6 an exemplary functional sequence of the electric driving system from FIG. 5.

In the figures, the functionally identical elements are provided with the same reference numerals.

### DETAILED DESCRIPTION

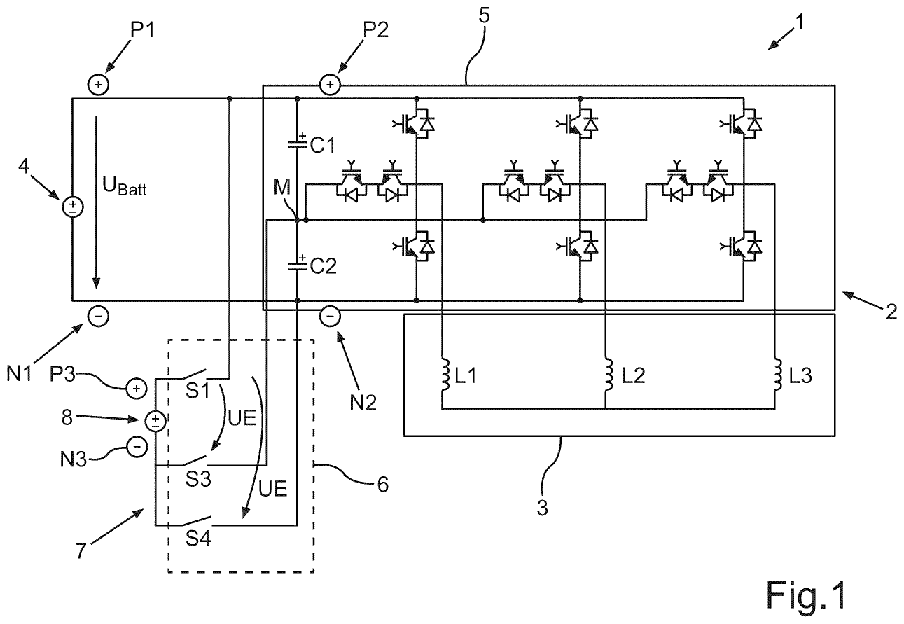

FIG. 1 illustrates, for example, a schematic block circuit diagram of an electric driving system 1 of a vehicle 2.

The electric driving system 1 is, in particular, an electric drive or an electric drive unit for driving the vehicle 2. In other words, the electric driving system 1 serves to drive the vehicle 2 for the purposes of locomotion. Consequently, a plurality of components or systems can belong to the electric driving system 1, with which the vehicle 2 can be driven.

For example, the electric driving system 1 can be referred to as a drive device, switching arrangement, or electric system.

The vehicle 2 may be an at least partially electrically operated vehicle, such as a hybrid vehicle or electric vehicle.

The electric driving system 1 may have an electric three-phase motor 3 to drive the vehicle 2. In particular, this electric three-phase motor 3 is an electric machine, in particular an electric motor. In particular, the electric three-phase motor 3 is operated in a motor operation and thus as an electric motor. In order to operate the electric three-phase motor 3 in the motor operation, the electric three-phase motor 3 can be supplied with an electric alternating voltage, in particular with a high-voltage electric alternating voltage, via its phases. The phases of the electric three-phase motor 3 can, for example, be connected to each other via a common neutral point.

So that the electric three-phase motor 3 can now be supplied with an alternating voltage, the electric driving system 1 and thus the vehicle 2 can have at least one electrical energy storage device 4. With the aid of the electrical energy storage device 4, the electric three-phase motor 3 and other vehicle components and/or vehicle systems and/or vehicle onboard electrical systems can be supplied with electrical energy.

For example, the electrical energy storage device 4 may be multiple individual batteries or a battery system. In particular, the electrical energy storage device 4 is a battery, in particular a vehicle battery. For example, the electrical energy storage device 4 can be referred to as a high-voltage battery.

With the aid of the electrical energy storage device 4, a battery voltage U_{Batt} can be provided. In particular, the vehicle 2 can be a battery-operated vehicle with a voltage level of 800 volts. A voltage of essentially 800 volts can be provided by means of the battery voltage U_{Batt}.

The electric three-phase motor 3 requires an alternating voltage for its operating state. This alternating voltage can be provided by means of an inverter 5. This takes place by transformation of the battery voltage U_{Batt} into an alternating voltage. The inverter 5 may be, for example, a power converter. In particular, the inverter 5 can be referred to as a drive inverter. In particular, the provision of the alternating voltage for the electric three-phase motor 3 takes place by the primary function or main function of the inverter 5.

For example, the inverter 5 may be interconnected or arranged between the electrical energy storage device 4 and the electric three-phase motor 3.

In particular, a positive potential P1 of the electrical energy storage device 4 is connected or wired with a positive potential P2 of the inverter 5. Similarly, a negative potential N1 of the electrical energy storage device 4 is connected or wired with a negative potential N2 of the inverter 5. In other words, the positive poles or plus poles of the electrical energy storage device 4 and of the inverter 5 are connected with each other. Similarly, the minus pole of the electrical energy storage device 4 is connected with the minus pole of the inverter 5.

Furthermore, a series circuit consisting of a first capacitor C1 and second capacitor C2 is switched or arranged between the positive potential P2 and the negative potential N2 of the inverter 5. In consideration of the electrical energy storage device 4, this series circuit is located at the input of the inverter 5, in particular directly between the inverter 5 and the electrical energy storage device 4. In particular, the positive potential of the first capacitor C1 is connected with the positive potential P2 of the inverter 5. The negative potential of the first capacitor C1 is connected with the positive potential of the second capacitor C2. Consequently, the negative potential of the second capacitor C2 is connected with the negative potential N2 of the inverter 5. A center tap M is located between the first and second capacitors C1, C2.

For example, the inverter 5 can be formed as a three-level T-type inverter.

In particular, the electric driving system 1 has a switching device 6. With the aid of the switching device 6, a wide variety of operating modes or charging modes or charging processes of the electrical energy storage device 4 may be set or switched. The switching device 6 may be referred to as a switching apparatus, switching arrangement or switching matrix.

An 800-volt charging process or a 400-volt charging process can be carried out depending on the switching state of the switching device 6. The electrical energy storage device 4 is directly connected by means of the switching device 6 for the 800-volt charging process of the electrical energy storage device 4. In the case of a 400-volt charging process of the electrical energy storage device 4, the switching device 6 charges the electrical energy storage device 4 indirectly via the inverter 5.

In a first switching state of the switching device 6, a positive potential P3 of a charging port 7 can be connected with the positive potential P1 of the electrical energy storage device 4. In this case, additionally, a negative potential N3 of the charging port 7 can be connected with the negative potential N1 of the electrical energy storage device 4. Consequently, the electrical energy storage device 4 can be directly charged with an input voltage UE which is applied to the charging port 7.

The charging port 7 may be, in particular, a charging port on the vehicle, such as a charging socket or charging point. In particular, the charging port 7 enables the coupling of the electric driving system 1 with a charging station 8 or charging pillar that is external to the vehicle 2. In particular, the charging station 8 is a DC charging station or a charging unit or charging infrastructure. In particular, the charging station 8 can be referred to as a direct current charging source.

The charging station 8 can be connected or switched via the charging port 7 using the switching device 6, either directly to the electrical energy storage device 4 or to the inverter 5.

In particular, the switching device 6 has different switching elements. For example, the switching device 6 may have a first charging contactor S1, a second charging contactor S2, a third charging contactor S3 and a fourth charging contactor S4. These charging contactors S1 to S4 may be, for example, contactors, switching elements, or mechanical switches. In this embodiment of FIG. 1, the switching device 6 has the first charging contactor S1, the third charging contactor S3, as well as the fourth charging contactor S4.

If the switching device now adopts the first switching state, the charging contactors S1, S4 are closed. Thus, the positive potentials P1, P3 are connected with each other. Likewise, the negative potentials N3, N1 are connected. The third charging contactor S3 is in the open state here.

In particular, the switching device 6 is always operated in the first switching state if the input voltage UE of the charging port 7 has a first predetermined voltage value. This, for example, is the case when an input voltage UE of 800 volts is available on the charging port 7. Thus, direct charging of the electrical energy storage device 4 takes place at an 800-volt charging station as a charging station 8.

In particular, the first switching state is set automatically by the switching device 6 or a control device or control unit of the electric driving system 1.

In particular, the switching device 6 can only ever have one switching state at any one moment. Should the switching state be changed, the current existing switching state of the switching device 6 is automatically changed into another or desired switching state.

In particular, the switching device 6 is set up to automatically change into the second switching state when the input voltage of each charging port has a second predetermined voltage value. In this case, the input voltage UE can have a voltage value of 400 volts. Thus, the charging station 8 provides a voltage with a voltage value of less than 500 volts DC. In this case, the transforming or stepping-up of this voltage takes place by means of the inverter 5. Consequently, a stepped-up operation of the inverter 5 takes place such that the input voltage UE which is lower than the battery voltage U_{Batt} can be stepped-up or transformed. In this state it is necessary to adjust or step-up the negative potential of the electrical driving system 1 and in particular of the vehicle 2. Consequently, the switching device 6 is to be switched in such a way that a second switching state is available. For example, this can take place automatically. In particular, it can be switched from the first switching state into the second switching state, for example. In particular, only one switching state is ever applied to the switching device 6 at any one moment.

In the second switching state of the switching device 6, the positive potential P3 of the charging port 7 is connected or interconnected or wired with the positive potential P1 of the electrical energy storage device 4 and the positive potential of the inverter 5. In this case, however, the negative potential N3 of the charging port 7 is connected with the center tap M of the inverter 5. This takes place via the third charging contactor S3. In the second switching state of the switching state 6, the charging contactors S1, S3 are closed and the fourth charging contactor S4 is opened. In this case, the input voltage UE can be provided to the inverter 5 such that the input voltage UE can be stepped-up by means of the specific embodiment of the inverter 5.

Thus, the inverter 5 is used to easily provide the backward compatibility for the vehicle 2. In order to achieve this backward compatibility (meaning the charging of an 800-volt vehicle at a 400-volt charging station), the inverter 5 can be formed as a three-level inverter, S3 inverter, or as a three-stage inverter in a T-type embodiment. In particular, the inverter 5 may be formed as a three-level inverter in NPC (Neutral Point Clamped) topology or as a three-point inverter in an NPC circuit.

In order to be able to transform the input voltage UE for the charging of the electrical energy storage device 4 by means of the inverter 5, the inverter 5 has three switching arrangements for each of the three phases of the electric three-phase motor 3. Thus, each of these switching arrangements can have a plurality of different semiconductors, such as IGBTs or MOSFETs. For example, the capacitors C1, C2 and the center tap M form an intermediate circuit of the inverter 5. In particular, the inverter 5 can be set up to charge the first capacitor C1 and/or the second capacitor C2 alternately, in particular cyclically. Thus, a sum of a first voltage of the first capacitor C1 and a second voltage of the second capacitor C2 can be generated or provided as an output voltage of the inverter, for example, for charging the electrical energy storage device 4. In particular, depending on which semiconductor switches of the inverter 5 are cycled, the inverter 5 can charge the first capacitor C1 or the second capacitor C2 with the input voltage UE. Thus, an output voltage corresponding to the battery voltage U_{Batt} can be provided with the aid of the series circuit consisting of C1 and C2. Consequently, the electrical energy storage device 4 can be charged via the capacitors C1, C2 of the inverter 5.

Consequently, it should be noted here that the inverter 5 has an alternative use for stepping-up the input voltage UE, as the actual primary function of the inverter 5 is to convert the battery voltage U_{Batt} into an alternating voltage for the electric three-phase motor 3. Accordingly, the inverter 5 has the additional secondary function of charging the electrical energy storage device 4 if a charging voltage of less than 500 volts can be provided by the charging station 8.

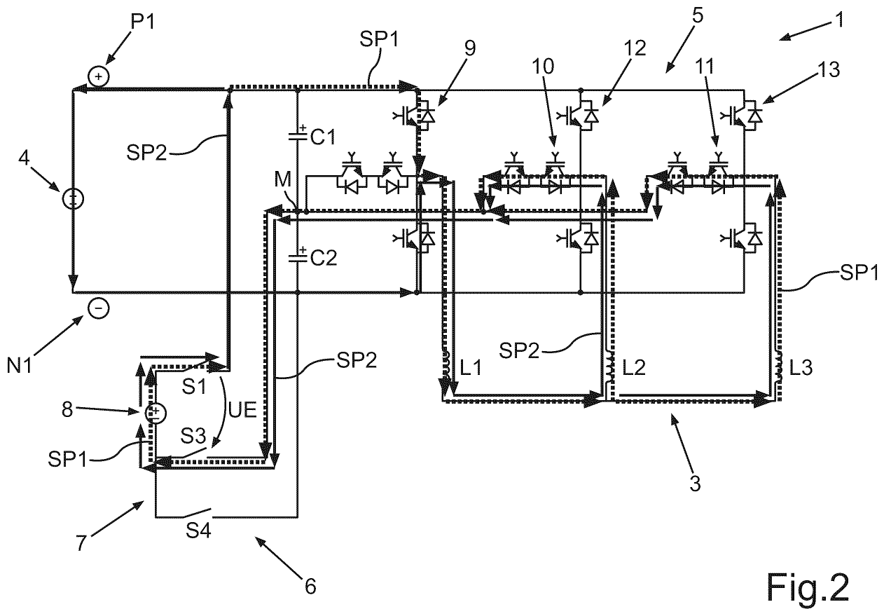

FIG. 2 illustrates, for example, an operation of the electric driving system 1 in which the switching device 6 is in the second switching state. For example, the current path SP1 represents the current path when a cycling or clocking semiconductor switch 9 of the inverter 5 is closed. Both semiconductor switches 10, 11 are permanently closed during the second switching state of the switching device 6. The remaining semiconductor switches of the inverter 5 can remain open or be closed for the efficiency optimization in the case of a conductive body diode.

In a following cycle operation or cycle, the current path SP2 is set. In particular, both current paths SP1, SP2 are present alternately. Thus, an alternating, cyclical current path SP1 or SP2 takes place. In current path SP2, the cycling semiconductor switch 9 is now open. Both semiconductor switches 10, 11 are still closed. Furthermore, instead of the semiconductor switch 9 of the left half-bridge of the inverter 5, the semiconductor switch 12 or 13 of the center or right half-bridge of the inverter 5 can also be used. Changing between the cycling semiconductor switches 9, 12, 13 would be advantageous in order to homogenize ageing defects.

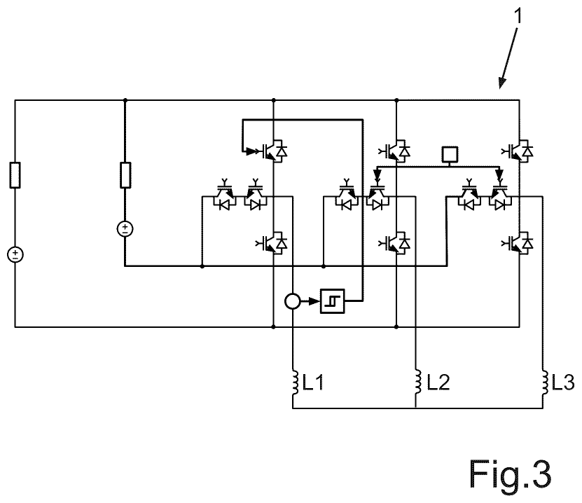

FIG. 3 illustrates a schematic simulation set-up of the electric driving system 1. Thus, the second switching state of the switching device 6 is simulated.

For example, capacitors C1 and C2 can be omitted to improve the clarity of the current rise and current freewheeling curves. The cycle frequency is 10 kilohertz for example, and each motor winding of the electric three-phase motor 3 is 1 millihenry. The cycling semiconductor switch 9 is activated when the current falls below 80 amps and opened when the current exceeds 150 amps.

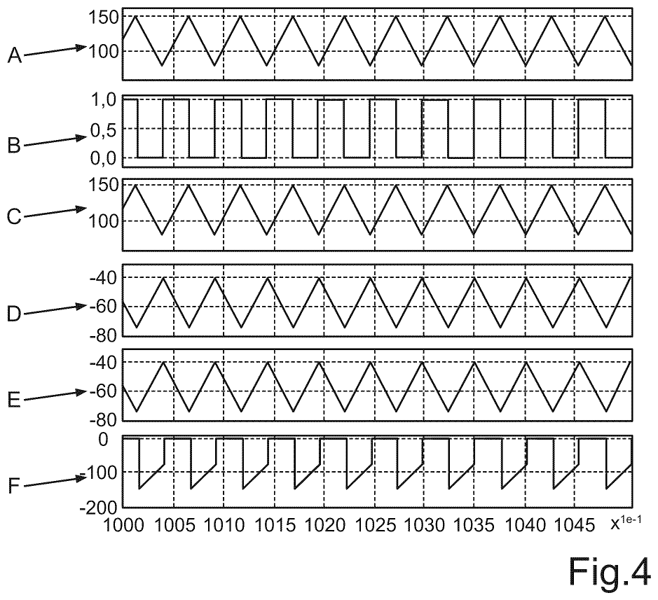

The exemplary results of the simulation from FIG. 3 are illustrated in FIG. 4. For example, the current of the charging station 8 is illustrated in curve A. Here it can be seen how the current increases with a constant gradient at 80 amps by activating the gate of the cycling semiconductor switch 9, until the semiconductor switch 9 opens again at 150 amps. This current is identical to the current in the motor windings of the electric three-phase motor 3. For example, the motor windings L2 and L3 have an opposite sign and the current is halved in comparison to the motor winding L1. This, in particular, can be seen in curves C, D and E. In curve C, the current of L1 is illustrated and in curves D and E, only the current of motor windings L2 and L3 is illustrated. In curve D, the activated gate of the cycling semiconductor switch 9 is illustrated. In curve F, for example, the current cycle in the electrical energy storage device 4 is represented. Charging of the electrical energy storage device 4 only takes place in the phase with the opened semiconductor switch 9 (freewheel phase), which corresponds to the typical behavior of a boost converter.

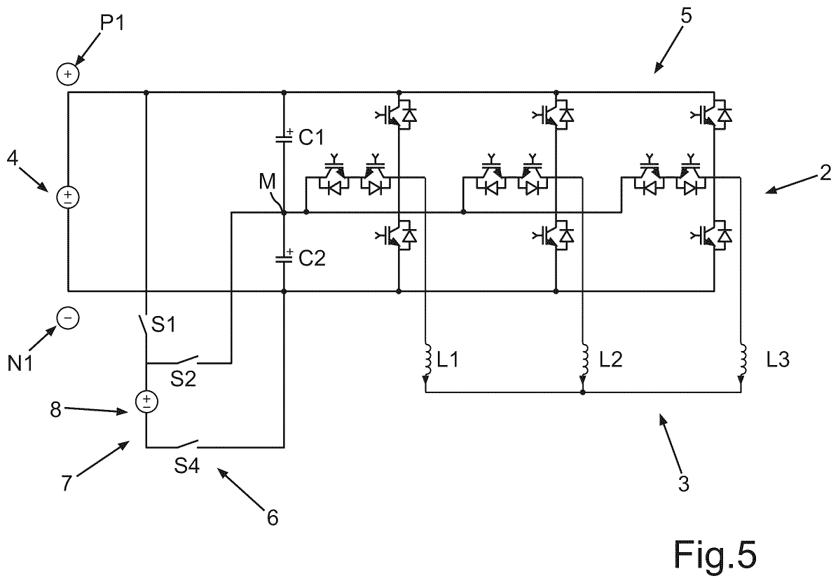

In FIG. 5 an exemplary case is illustrated with which the switching device 6 is located in the third switching state. The third switching state can similarly be switched or changed automatically. The third switching state is then adopted when the input voltage UE has the second predetermined voltage value, in particular 400 volts, at the charging port 7. In this case, the increase of the positive potential of the electric driving system 1 or of the vehicle 2 takes place by means of the inverter 5. In the third switching state, the positive potential of the charging port 7 can be connected with the center tap M of the inverter 5. The negative potential N3 of the charging port 7 can be connected or interconnected with the negative potential N2 of the inverter 5. Thus, the charging of the electrical energy storage device 4 likewise takes place with the aid of the inverter 5. In this case, the first capacitor C1 and the second capacitor C2 are also charged alternately, similarly to the second switching state. In this case, the sum of the first voltage of the first capacitor C1 and the second voltage of the second capacitor C2 can be provided or generated as an output voltage of the inverter 5. In this case, the second charging contactor S2 and the fourth charging contactor S4 can be closed. In particular, in this embodiment, the switching device 6 can have the first charging contactor S1, the second charging contactor S2 and the fourth charging contactor S4.

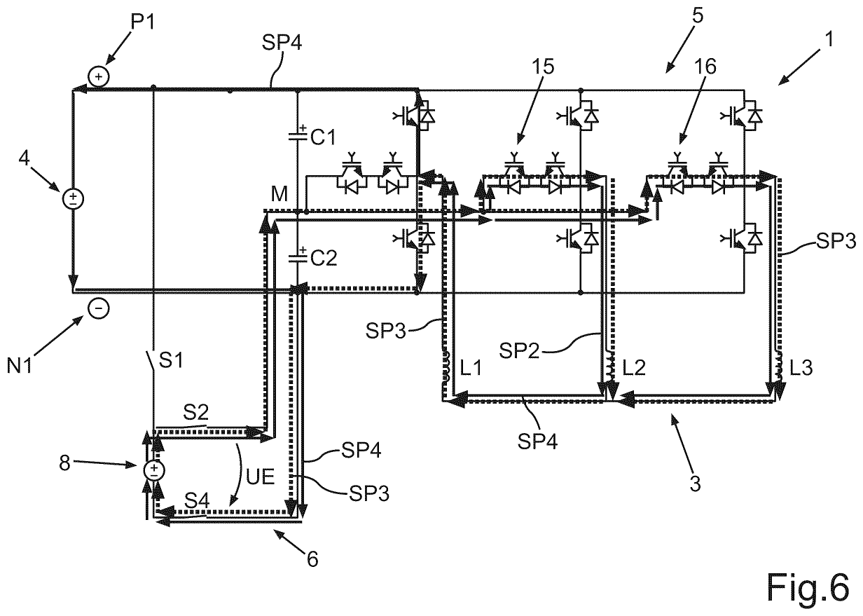

In FIG. 6, only the respective current paths SP3, SP4 are represented in an analogous manner to FIG. 2. However, the operating manner of the electric driving system 1 during or with the third switching state of the switching device 6 is shown here.

The current path SP3 represents the current path with which the semiconductor switch 14 of the inverter 5 is operated cyclically. Both semiconductor switches 15, 16 can be permanently closed. In particular, in this current path SP3 the semiconductor switch 14 is closed.

In an analogous manner to what has been said in respect of FIG. 2, the two current paths SP3 and SP4 are not carried out simultaneously, but alternately. In current path SP4 the semiconductor switch 14 is now open.

The other semiconductor switches can likewise remain open here or be closed for the efficiency optimization in the case of a conductive body diode.

Similarly to what has been said above in respect of FIG. 2, the semiconductor switches of the respective half-bridges of the inverter 5 can likewise be used alternately.

With regard to the simulation set-up and simulation results, the simulation set-up and simulation results of FIGS. 3 and 4 can be considered here in an analogous way.

List of reference numerals

| | |
|---|---|
| 1 | Electric driving system |
| 2 | Vehicle |
| 3 | Electric three-phase motor |
| 4 | Electrical energy storage device |
| 5 | Inverter |
| 6 | Switching device |
| 7 | Charging port |
| 8 | Charging station |
| 9 to 16 | Semiconductor switch |
| C1, C2 | First and second capacitor |
| L1, L2, L3 | Motor windings |
| U_{Batt} | Battery voltage |
| UE | Input voltage |
| P1, P2, P3 | Positive potentials |
| N1, N3, N3 | Negative potentials |
| S1, S2, S3, S4 | First to fourth charging contactors |
| SP1, SP2, SP3, SP4 | Current paths |

1-9. (canceled)

10. An electric driving system for a vehicle, the electric drive system comprising:
an electric three-phase motor;
an electrical energy storage device configured to supply electricity to the electric three-phase motor;
an inverter connected to the electric three-phase motor, wherein a positive potential of the electrical energy storage device is connected with a positive potential of the inverter and a negative potential of the electrical energy storage device is connected with a negative potential of the inverter;
a series circuit, consisting of a first capacitor and a second capacitor, which is switched between the positive and negative potential of the inverter, wherein a center tap of the inverter is formed between the first capacitor and the second capacitor; and
a switching device configured to have a first switching state and at least one of a second and third switching state, wherein
in the first switching state a positive potential of a charging port is connected with the positive potential of the electrical energy storage device and a negative potential of the charging port is connected with a negative potential of the electrical energy storage device such that the electrical energy storage device is chargeable with an input voltage applied to the charging port,
in the second switching state the positive potential of the charging port is connected with the positive potential of the electrical energy storage device and the negative potential of the charging port is connected with the center tap of the inverter such that the electrical energy storage device is chargeable depending on the inverter, and
in the third switching state the positive potential of the charging port is connected with the center tap of the inverter and the negative potential of the charging port is connected with the negative potential of the inverter, such that the electrical energy storage device is chargeable depending on the inverter, and
wherein the inverter is configured to charge the first capacitor or the second capacitor, and a sum of a first voltage of the first capacitor and of a second voltage of the second capacitor is provided as an output voltage of the inverter to charge the electrical energy storage device.

11. The electric driving system of claim 10, wherein the inverter is a 3-level T-type inverter.

12. The electric driving system of claim 10, wherein the inverter is configured to
adjust a voltage difference between a battery voltage of the electrical energy storage device and the input voltage in the second switching state by reducing a voltage level of the negative potentials of the electrical energy storage device, the inverter, and the charging port by the voltage difference between the battery voltage of the electrical energy storage device and the input voltage in the second switching state, and
adjust a voltage difference between the battery voltage and the input voltage in the third switching state by increasing a voltage level of the positive potentials by the voltage difference between the battery voltage and the input voltage in the third switching state.

13. The electric driving system of claim 10, wherein the switching device comprises:
first and second charging contactors or third and fourth charging contactors,
wherein the first charging contactor is configured to connect the positive potential of the charging port with the positive potential of the electrical energy storage device,
the second charging contactor is configured to connect the positive potential of the charging port with the center tap of the inverter,
the third charging contactor is configured to connect the negative potential of the charging port with the center tap of the inverter, and
the fourth charging contactor is configured to connect the negative potential of the charging port with the negative potential of the electrical energy storage device.

14. The electric driving system of claim 10, wherein the switching device is configured to automatically switch to the first switching state when the input voltage of the charging port has a first predetermined voltage value.

15. The electric driving system of claim 14, wherein the switching device is configured to automatically switch to the second switching state when the input voltage of the charging port has a second predetermined voltage value and the inverter is operated as a boost converter to reduce a voltage level of the negative potentials.

16. The electric driving system of claim 14, wherein the switching device is configured to automatically switch to the third switching state when the input voltage of the charging port has a second predetermined voltage value and the inverter is operated as a boost converter to increase a voltage level of the positive potentials.

17. A vehicle comprising:
an electric driving system, which comprises
an electric three-phase motor;
an electrical energy storage device configured to supply electricity to the electric three-phase motor;
an inverter connected to the electric three-phase motor, wherein a positive potential of the electrical energy storage device is connected with a positive potential of the inverter and a negative potential of the electrical energy storage device is connected with a negative potential of the inverter;
a series circuit, consisting of a first capacitor and a second capacitor, which is switched between the positive and negative potential of the inverter, wherein a center tap of the inverter is formed between the first capacitor and the second capacitor; and
a switching device configured to have a first switching state and at least one of a second and third switching state, wherein
in the first switching state a positive potential of a charging port is connected with the positive potential of the electrical energy storage device and a negative potential of the charging port is connected with a negative potential of the electrical energy storage device such that the electrical energy storage device is chargeable with an input voltage applied to the charging port,
in the second switching state the positive potential of the charging port is connected with the positive potential of the electrical energy storage device and the negative potential of the charging port is connected with the center tap of the inverter such that the electrical energy storage device is chargeable depending on the inverter, and
in the third switching state the positive potential of the charging port is connected with the center tap of the inverter and the negative potential of the charging port is connected with the negative potential of the inverter, such that the electrical energy storage device can be charged depending on the inverter, and
wherein the inverter is configured to charge the first capacitor or the second capacitor, and a sum of a first voltage of the first capacitor and of a second voltage of the second capacitor is provided as an output voltage of the inverter to charge the electrical energy storage device.

18. A method for operating an electric driving system comprising an electric three-phase motor, an electrical energy storage device configured to supply electricity to the electric three-phase motor, an inverter connected to the electric three-phase motor, wherein a positive potential of the electrical energy storage device is connected with a positive potential of the inverter and a negative potential of the electrical energy storage device is connected with a negative potential of the inverter, a series circuit, consisting of a first capacitor and a second capacitor, which is switched between the positive and negative potential of the inverter, wherein a center tap of the inverter is formed between the first capacitor and the second capacitor, and a switching device configured to have a first switching state and at least one of a second and third switching state, wherein the inverter is configured to charge the first capacitor or the second capacitor, and a sum of a first voltage of the first capacitor and of a second voltage of the second capacitor is provided as an output voltage of the inverter to charge the electrical energy storage device, the method comprising:
supplying the electric three-phase motor with electricity with the electrical energy storage device; and
switching the switching device into the first, second, or third switching state based on the input voltage, wherein
wherein, in the first switching state, a positive potential of a charging port is connected with the positive potential of the electrical energy storage device and a negative potential of the charging port is connected with a negative potential of the electrical energy storage device such that the electrical energy storage device is chargeable with an input voltage applied to the charging port,
wherein, in the second switching state, the positive potential of the charging port is connected with the positive potential of the electrical energy storage device and the negative potential of the charging port is connected with the center tap of the inverter such that the electrical energy storage device is chargeable depending on the inverter, and
wherein, in the third switching state, the positive potential of the charging port is connected with the center tap of the inverter and the negative potential of the charging port is connected with the negative potential of the inverter, such that the electrical energy storage device is chargeable depending on the inverter.
